(19) United States
(12) Patent Application Publication
(10) Pub. No.: US 2006/0154211 A1
(43) Pub. Date: Jul. 13, 2006

(54) Prefabricated pediatric crowns and method of producing prefabricated pediatric crowns

(76) Inventors: Larry W. Bybee, Pocatello, ID (US); Russ Misner, Pocatello, ID (US); John Peldyak, Mt. Pleasant, MI (US)

Correspondence Address: Hillary J. Morgan, Attorney at Law, 890 S. 500 E., Orem, UT, 84097, US

(21) Appl. No.: 11/034,299

(22) Filed: Jan. 12, 2005

(51) Int. Cl. A61C 5/08; A61C 13/08

(52) U.S. Cl. 433/218; 433/223; 264/19

(57) ABSTRACT

The present invention is directed toward an aesthetic prefabricated pediatric crown used to efficiently treat extensive carious lesions in primary and permanent teeth in children. The prefabricated crown is solidly formed from tooth colored materials, having the ability to provide aesthetics, superior strength, and durability. The present invention also relates generally to a prefabricated pediatric crown that is mass produced in various shades and sizes for the primary dentition. A method for producing the present invention is also disclosed.

### BACKGROUND OF THE INVENTION

1. The Field of the Invention

The present invention is in the field of dental prosthetics. More particularly, the invention relates to prefabricated pediatric crowns and a method for making prefabricated pediatric crowns.

2. The Relevant Technology

There are several options available to a dental practitioner when treating extensive carious lesions in children. If the decay requires treating a large portion of the tooth, a crown is usually used. There are two main types of crowns in pediatric dentistry: custom-fit crowns and prefabricated crowns.

Custom-fit crowns are very durable and aesthetically pleasing since they can be made from strong materials that resemble the color of natural teeth. Such materials may include various forms of porcelain, ceramic, resin, ceramic-resin hybrid, composite resin, plastic, glass, polycarbonate porcelain, etc. The process for making a custom-fit crown generally includes: preparing the designated tooth, taking an impression of the tooth, having a custom-fit crown made that individually fits the patient's tooth, and later fitting the custom crown to the prepped tooth. Although this process produces a strong and aesthetically pleasing crown, it is expensive and time intensive. It requires multiple visits to the dental office and a considerable amount of a dental practitioner's time to provide the treatment. As one can imagine, this process can be especially difficult when treating children. Children may easily complicate and prolong the process by refusing to cooperate, excessively gagging, or by being scared, restless, etc. Therefore, because of the extensive time required and the general lack of cooperation of children, custom-fit crowns are rarely used in pediatric dentistry.

Prefabricated crowns are commonly used to treat extensive carious lesions in children. Prefabricated pediatric crowns are extremely useful because they allow a dental practitioner to treat carious lesions in a relatively short amount of time, in comparison with the procedure for making custom-fit crowns. The procedure for placing a prefabricated crown generally requires prepping the designated tooth and mounting the prefabricated crown to the tooth structure by various attachment means. This treatment can usually be completed within one office visit. Since timing is of the essence in pediatric dentistry, this quick alternative to custom-fit crowns enables a dental practitioner to provide treatment in a relatively short amount of time, as well as sustain a child's cooperation and contentment.

There are several types of prefabricated crowns used in pediatric dentistry. One of the most well-known choices is preformed stainless steel crowns. These crowns are formed out of a malleable stainless steel material and are anatomically shaped so as to have a natural looking contour, height, and occlusal surface. Stainless steel crowns can be cut, trimmed, or crimped in order to provide a comfortable fit within the oral cavity. Stainless steel crowns have excellent strength qualities and are very durable, capable of providing long-term coverage. However, stainless steel crowns have a very unattractive appearance and many people, including children, have difficulty in accepting the “silver crown smile.” Children can be especially sensitive to comments from peers that point out the distinguishing characteristics of their smile, which undoubtedly affects their self-esteem. Stainless steel crowns can also be irritating to the surrounding gingiva and can cause sensitivity in some individuals resulting in local inflammation. Such disadvantages have led to attempts in the art to improve upon these crowns.

Stainless steel crowns with one or more resin surfaces is another common choice for prefabricated pediatric crowns. These crowns usually consist of a resin veneer or coating that is bonded to one or more surfaces of a stainless steel crown through various bonding means. Since such crowns utilize stainless steel material, the crowns provide the strength for mastication that is characteristic of the stainless steel crown. The crowns also provide a more aesthetic appearance with the resin surfaces having a natural tooth-like color. However, these crowns are still not completely aesthetically pleasing. Since only some of the surfaces are covered with resin, some of the remaining stainless steel surfaces are still visible from certain angles. Also, the resin surfaces are prone to fracturing, chipping, and/or peeling after time under normal use and mastication. Such wearing of the resin leads to exposed stainless steel portions that are even more noticeable than before, being offset by the surrounding white resin surfaces. The whiteness of the resin surfaces are also prone to dulling from normal mastication and tooth brushing over time, therefore not looking as shiny or white as teeth. Also unfortunately, staining of the resin surfaces can occur from food and other substances introduced into the oral cavity, therefore not appearing as natural or tooth-like.

Another choice for prefabricated pediatric crowns is strip crowns. Strip crowns are generally a clear shell in the form of a pediatric tooth, which a dental practitioner fills with flowable resin material and then pushes onto the desired prepped tooth. The resin material is then usually light cured so that it hardens. In some varieties of strip crowns, the shell can then either be removed or stay permanently attached to the resin filling. Although strip crowns provide an aesthetically pleasing alternative, the crowns do not have superior strength capabilities and commonly fracture or break under normal occlusion. Another disadvantage to strip crowns is that they are more time-intensive for a dental practitioner to use than the above mentioned varieties of the stainless steel crowns. Longer treatment times can lead to less productivity and cooperation with the child patient and are therefore not an adequate solution.

In view of the foregoing, there is an ongoing need in pediatric dentistry for prefabricated crowns that offer improved aesthetics, superior strength, and durability. Such improvements would lead to more efficient treatment by dental practitioners and increased satisfaction from patients and parents.

### BRIEF SUMMARY OF THE INVENTION

The present invention is directed toward an aesthetic prefabricated pediatric crown used to treat extensive carious lesions in primary and permanent teeth in children.

A first general aspect of the invention provides a prefabricated pediatric crown comprising a crown structure formed of tooth colored materials, wherein the crown structure is created by utilizing a crown form, further wherein the structure is fashioned from a tooth colored milling block by machining processes.

A second general aspect of the invention provides a method for producing one or more prefabricated pediatric crowns comprising using a crown form, utilizing the crown form to resemble a crown prep or other tooth structure, and using a milling block and machining processes to form the desired prefabricated pediatric crown.

A third general aspect of the invention provides a method for producing one or more prefabricated pediatric crowns comprising imbedding a crown form into a holding agent, pouring a hardening agent over various surfaces of the crown form, removing the holding agent and using a filling agent to base out the hardening agent to the gingival margin level, placing a replicating material into the lumen of the crown form and surrounding areas, placing the replicating material into a stabilizing material, removing the hardening agent and the designated crown form, and using machining processes to measure and produce the desired pediatric crown.

These and other features of the present invention will become more fully apparent from the following description and appended claims, or may be learned by the practice of the invention as set forth hereinafter.

### BRIEF DESCRIPTION OF TH DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 illustrates the placement of one or more crown forms in a holding agent.

FIG. 2 depicts the placement of a hardening agent on various surfaces of the crown forms.

FIG. 3 illustrates the lumen and lumen border of the crown forms and the placement of a filling agent that bases out the gingival margins surrounding the crown forms.

FIG. 4 demonstrates the application of the replicating material into the lumen of the crown forms and surrounding filling agent. Also illustrated is a stabilizing material within a container.

FIG. 5 illustrates the placement of the mass of materials into the stabilizing material so that the replicating material and/or filling agent is affixed to the stabilizing material.

FIG. 6 depicts the removal of the crown forms, so that the replicating material is separated from the lumen of the crown forms. The replicating material now thereby resembling prepped teeth, dyes, or other tooth forms.

FIG. 7 demonstrates replicating material that resembles a prepped tooth, dye, or other tooth form between two pre-existing prefabricated pediatric crowns.

FIG. 8 illustrates a prefabricated pediatric crown formed from a milling block through machining processes.

### DETAILED DESCRIPTION OF THE PREFERRED EMBODIMENTS

I. Introduction

A detailed description of the invention will now be provided with specific reference to figures illustrating embodiments of the invention. It will be appreciated that like structures will be provided with like reference designations

The present invention is directed toward an aesthetic prefabricated pediatric crown used to treat extensive carious lesions in the primary dentition. An exemplary prefabricated crown, as depicted in FIG. 8, is a tooth-like crown structure formed from tooth colored materials, as described in more detail below, having the ability to look natural and provide an aesthetically pleasing appearance. The prefabricated crown has superior color stability and is not prone to staining, dulling, peeling, or chipping. The present invention also has superior strength and is able to withstand mastication and occlusion over a long period of time. The prefabricated crown is friendly to surrounding gingival tissues. Due to its prefabricated nature, the present invention also enables a dental practitioner to provide aesthetic, yet efficient treatment in treating extensive carious lesions in children. Many of the time intensive processes and office visits that are normally associated with such extensive treatment are eliminated based on the efficiency and aesthetics of the present invention.

Although it is intended that the present invention relates to pediatric prefabricated crowns, it is understood that the non-limiting exemplary methodologies described below may also be used to create adult prefabricated crowns if the art so required of it.

II. An Exemplary Method for Making a Prefabricated Pediatric Crown

One of the advantages of the present invention is that an aesthetic pediatric crown can be formed without many of the hassles and procedures that are normally associated with making a tooth colored custom fit crown on children. For example, instead of having to perform many of the required procedures within a patient's oral cavity, the present invention illustrates a method for masking a prefabricated pediatric crown that does not require such extensive contact with the patient.

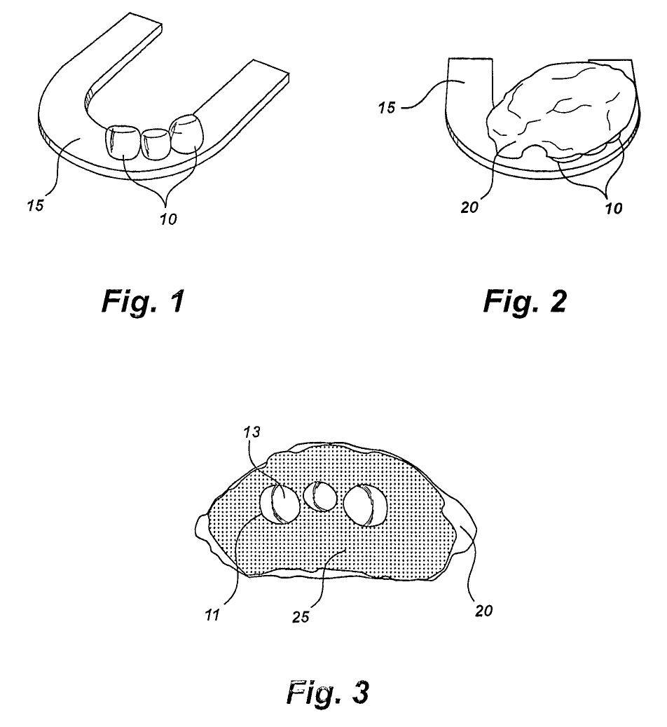

To form the prefabricated pediatric crown, the present invention utilizes, among other things, a crown form that acts as a prototype of a pediatric tooth, teeth, arch, dentition or other model. The crown form is any type of object/material that resembles a pediatric tooth, teeth, arch, dentition, or other model. In all embodiment illustrated in FIG. 1, the crown form 10 may be a prefabricated stainless steel crown. In other embodiments, various types of prefabricated pediatric crowns can be used as crown forms 10. Furthermore, in additional embodiments, the crown form 10 may be a pediatric denture crown, dye, or any type of model of a pediatric tooth/dentition made out of plastic, wax, plaster, glass or other materials.

In an embodiment, the crown form 10 may be held or stabilized by a holding agent 15. FIG. 1 is a non-limiting example of a plurality of crown forms 10 imbedded into a holding agent 15. The holding agent 15 may be any type of material that is capable of holding and securing the crown form 10 so that the processes necessary to form the pediatric crown can be performed. In an embodiment depicted in FIG. 1, the holding agent 15 may be a piece of wax. Although FIG. 1 depicts the holding agent 15 in a “U” shape that resembles an oral arch, this example is not to be limiting. Any shape or size of a holding agent 15 can be used so long as it is capable of holding one or more crown forms 10 in its desired place. In other embodiments, the holding agent 15 may include clay, putty, gum, alginate, plaster, heated green stick compound, or any other soft, semi-hard, or pliable material that is capable of holding a crown form securely in its proper place. In the illustrated embodiment, the crown form 10 may be imbedded into the holding agent 15 in the place as desired by the dental practitioner. However, in other embodiments, the crown form 10 may already be connected or secured to a holding agent 15. In such alternative embodiments, the holding agent 15 may include the base form of a dental model, dentiform, denture set, or other model or replica of the pediatric dentition or teeth.

In an embodiment illustrated in FIG. 2, a stabilizing agent 20 may be poured over the various surfaces of the crown form 10, such as the occlusal and marginal surfaces as depicted in FIG. 2. The stabilizing agent 20 may be any substance that secures the angulation and spacing of the crown form 10 as intended when the crown form 10 was initially placed or held by the holding agent 15. In some embodiments, the stabilizing agent 20 may also be designed to ensure and maintain the desired placement, angulation, and spacing of the crown form 10 if the holding agent 15 is removed. In an embodiment illustrated in FIG. 2, the stabilizing agent 20 may be plaster. In the illustrated embodiment, the plaster may be mixed with water to the desired consistency and then spread upon the occlusal and marginal surfaces of the crown forms 10. The plaster then may be dried to become a hard substance, therefore locking the crown form(s) 10 into their designated positions. The stabilizing agent 20 may include any substance that is capable of stabilizing and securing the placement of the crown form 10. In alternative embodiments, the stabilizing agent 20 may include plaster, stone, alginate, sticky wax, green stick compound, or any other material known in the art that is capable of providing such a function.

In an embodiment, once the stabilizing agent 20 has hardened and has secured the placement of the crown form 10, the holding agent 15 may be removed. As demonstrated in an embodiment as shown in FIG. 3, a filling agent 25 may then be applied. The filling agent 25 may be material that is used to “base out” or resemble the natural surrounding gingival contours and margins. The filling agent 25 can be made out of any pliable material that is capable of being shaped and molded into the desired gingival contours. In an embodiment illustrated in FIG. 3, the filling agent 25 may be wax. However, in other embodiments, the filling agent 25 may be clay, putty, gum, alginate, plaster, heated green stick compound, or any other soft, semi-hard, or pliable material that is capable of being molded to replicate gingival contour. As depicted in FIG. 3, the filling agent 25 is formed around the crown forms 10 so that the lumen border 11 of the crown forms 10 remain exposed.

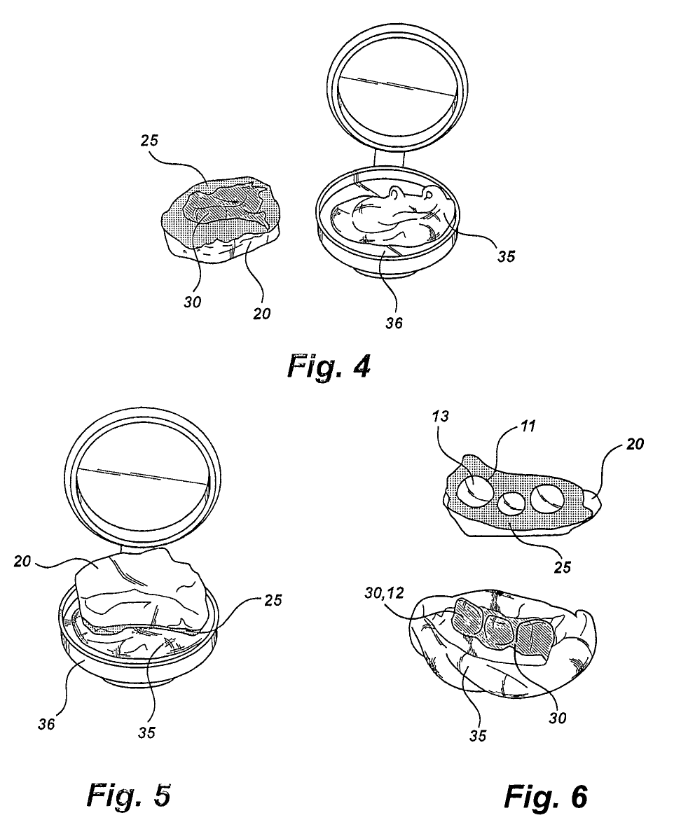

FIG. 4 illustrates the use of a replicating material 30 in an embodiment. The replicating material 30 may be used to replicate the lumen 13 of the crown form 10. Impression material may be used as a replicating material 30. However, any material that is capable of duplicating the lumen 13 of the crown form 10 may be an alternative in other embodiments. For example, some non-limiting examples may include plaster or flowable resin material. In an embodiment, replicating material 30 may be placed inside the lumen 13 of the crown form 10 and allowed to harden or solidify, if needed. As shown later in FIG. 6, once the replicating material 30 is removed from the lumen 13 of the crown form 10, in an embodiment, the replicating material 30 may resemble a prepped tooth 12. However, in other embodiments, the replicating material 30 may also look like other non-limiting examples, such as a dye or other model of a pediatric tooth/teeth.

FIG. 4 also illustrates the use of a supporting material 35 in an embodiment. Supporting material 35 may be used to stabilize and solidify the mass of materials, acting as a base or foundation. As depicted, supporting material 35 may be placed within a container 36 of a predetermined shape or size. As illustrated in FIG. 5, the replicating material 30 and/or filling agent 25 may be placed adjacent to the supporting material 35. If needed, the supporting material 35 is allowed to harden. In an embodiment, heavy bodied impression material may be used as a supporting material 35.

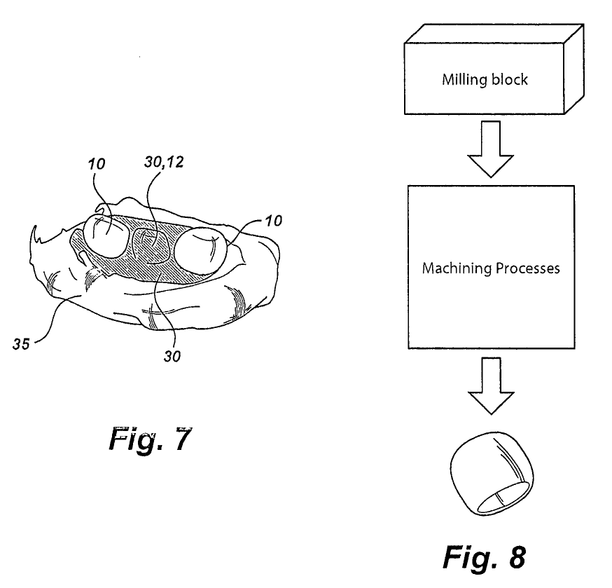

FIG. 6 demonstrates the separation of the replicating material 30 from the crown form 10 in an embodiment. As already mentioned, the replicating material 30 may resemble a prepped tooth 12 in an embodiment. However, in alternative embodiments, the replicating material 30 may resemble a dye or other form of a pediatric tooth/teeth. In forming and machining the pediatric crown, various embodiments can be used in regards to the replicating material 30. One embodiment may require only a solitary “prepped tooth” 12 formed of replicating material 30. Other embodiments may have multiple “prepped teeth” 12 formed of replicating material 30 adjacent to one another as depicted in FIG. 6. Another embodiment might include one or more “prepped teeth” 12 formed of replicating material 30 situated between two or more crown forms 10 as illustrated in FIG. 7.

In an embodiment, once the desired prepped tooth (teeth) 12 formed of replicating material 30 is exposed and ready, machining processes may then be used to form the tooth colored prefabricated pediatric crown(s) as referred to in FIG. 8. However, in alternative embodiments, a crown form 10 may also be used by machining processes to form the prefabricated pediatric crown.

In recent years, technological advances have provided machining processes capable of fabricating dental prosthetics using minimal human labor and drastically lower work time. This type of “digital dentistry” usually combines optic (whether that be laser, infrared, or other), digitizing equipment, CAD/CAM (computer-aided design/computer aided machining) and mechanical milling tools. The machining processes collect data that is representative of the patient's designated tooth structure and then uses the data to fabricate a prosthetic that, when completed, closely matches the shape of natural tooth structure. The machining processes produce a dental prosthetic by cutting, milling, and grinding the near-exact shape and morphology of the required restorative with greater speed and lower labor requirements than hand-made procedures. Examples of such machining processes include, but are not limited to, the CEREC 2™ and CEREC 3™ machines available from Sirona Dental Systems of Bensheim, Germany, the Evolution D4D™ available from Sullivan-Schein, of Melville, N.Y., the DICEM™ machine from Dentronix, the VITA CELAY™ machine from Vita Zahn Fabrik of Bad Säckingen, Germany, the PRO-CAM™ machine from CadCam Ventures, of Dallas, Tex. and the PROCERA ALL CERAM™ machine from Nobel Biocare USA of Westmont, Ill. U.S. Pat. Nos. 4,837,732, 4,776,704 and 4,575,805, as well as PCT Patent Application No. WO 96/37163 also disclose systems for making dental prosthetics using computer-aided milling machines.

Fabrication of a prosthetic using such machining processes may require, amongst other things, a mill blank as depicted in FIG. 8. A mill blank may be a solid block of material from x which the prosthetic is cut, carved, or formed. Although FIG. 8 depicts a mill blank in a “block” shape, this example is not to be limiting. Various shapes and sizes of a mill blank are capable of being used. In an embodiment, the mill blank may be made of tooth colored material(s). Non-limiting examples of such materials may include various forms of porcelain, ceramic, resin, ceramic-resin hybrid, composite resin, plastic, glass, or any other suitable tooth colored material.

After the pediatric crown is formed by machining processes, additional minor steps such as polishing, manual reshaping, or other necessary modifications of the formed pediatric crown may be required by the dental practitioner to ensure a pleasing appearance and proper fit within the patient's dentition.

As earlier mentioned, the prefabricated pediatric crown may be mass produced and made available for sale in various shades and sizes. Moreover, the prefabricated pediatric crown may be sold individually, in bulk quantities, or within a set. Some non-limiting set combinations may include sets specifically designed from the maxillary arch, maxillary anteriors, maxillary posteriors, mandibular arch, mandibular anteriors, and mandibular posteriors, for example.

III. An Alternative Exemplary Method for Making a Prefabricated Pediatric Crown

As briefly mentioned above, an embodiment may utilize a crown form 10 to form a prefabricated pediatric crown by machining processes. The crown form 10 may be placed in a holding agent 15 as depicted in FIG. 1, or may already be a part of or attached to a pre-formed holding agent 15. Some non-limiting examples of any holding agent 15 may include clay, putty, gum, alginate, plaster, heated green stick compound, an existing dentiform, denture set, or any other model of a pediatric tooth or dentition, or any other soft, semi-hard, or pliable material that is capable of holding a crown form 10 securely in its proper place.

Where an embodiment utilizes a crown form 10 placed within or already a part of or attached to a holding agent 15, various modes of performing the above described methodology may be applied as needed. In some embodiments, all of the above-mentioned methodology would be used, while in other embodiments, perhaps only a part of the steps would be applied. For example, although not to be limiting, in some embodiments a prepped tooth 12 formed of replicating material 30 may be used by machining processes to form a prefabricated pediatric crown. While in alternative embodiments, a crown form 10 may be used by machining processes to form the prefabricated pediatric crown.

In either event, the crown form may be used to form or resemble something similar to a “prepped tooth,” dye, or other tooth form as desired. Once that is accomplished and any other needed steps are completed, machining processes may then form the pediatric crown as desired. In an embodiment, a tooth colored milling block is utilized by machining processes to fashion the prefabricated pediatric crown. Additional minor steps such as polishing, manually reshaping, or other necessary modifications of the formed pediatric crown may also be required to ensure a pleasing appearance and proper fit within the patient's dentition.

As described above, the prefabricated pediatric crown may be mass produced and made available for sale in various shades and sizes. Moreover, the prefabricated pediatric crown be possibly sold individually, in bulk quantities, or within a set. Some non-limiting set combinations may include sets specifically designed for the maxillary arch, maxillary anteriors, maxillary posteriors, mandibular arch, mandibular anterior-s, and mandibular posteriors, for example.

What is claimed is:

1. A prefabricated pediatric crown comprising:
a crown structure formed of tooth colored materials, wherein the structure is created by utilizing a crown form, further wherein the structure is fashioned from a tooth colored milling block by machining processes.

2. A prefabricated pediatric crown in accordance with claim 1, wherein the crown form is a preformed pediatric crown.

3. A prefabricated pediatric crown in accordance with claim 1, wherein the crown form is a dye.

4. A prefabricated pediatric crown in accordance with claim in 1, wherein the prefabricated pediatric crown is formed of porcelain, ceramic, resin, ceramic-resin hybrid, composite resin, plastic, glass, polycarbonate porcelain, or any other suitable tooth colored material.

5. A prefabricated pediatric crown in accordance with claim 1, wherein a plurality of crown forms are used.

6. A prefabricated pediatric crown in accordance with claim 1, wherein the prefabricated pediatric crown is mass produced in accordance with desired size, function, or color.

7. A prefabricated pediatric crown in accordance with claim 1, wherein various sets of prefabricated pediatric crowns are mass produced.

8. A method for producing one or more prefabricated pediatric crowns comprising:
a. using a crown form,
b. utilizing the crown form to resemble a crown prep or other tooth structure,
c. using a milling block and machining processes to form the desired prefabricated pediatric crown.

9. A method for producing one or more pediatric crowns in accordance with claim 8, wherein the crown form is a preformed pediatric crown.

10. A method for producing one or more pediatric crowns in accordance with claim 8, wherein the crown form is a dye form.

11. A method for producing one or more pediatric crowns in accordance with claim 8, wherein the machining processes uses a milling block of a tooth colored material.

12. A method for producing one or more pediatric crowns in accordance with claim 8, wherein the prefabricated pediatric crown is formed of porcelain, ceramic, resin, ceramic-resin hybrid, composite resin, plastic, glass, polycarbonate porcelain, or any other suitable tooth colored material.

13. A method for producing one or more pediatric crowns in accordance with claim 8, wherein the prefabricated pediatric crown is mass produced in accordance with desired size, function, or color.

14. A method for producing one or more pediatric crowns in accordance with claim 8, wherein various sets of prefabricated pediatric crowns are mass produced for the primary dentition.

15. A method for producing one or more prefabricated pediatric crowns comprising:
a. imbedding a crown form into a holding agent,
b. pouring a hardening agent over various surfaces of the crown form,
c. removing the holding agent and using a filling agent to base out the hardening agent to the gingival margin level,
d. placing a replicating material into the lumen of the crown form and surrounding
e. placing the replicating material into a stabilizing material,
f. removing the hardening agent and the designated crown form,
g. using machining processes to measure and produce the desired pediatric crown.

16. A method for producing one or more pediatric crowns in accordance with claim 15, wherein the crown form is a preformed pediatric crown.

17. A method for producing one or more pediatric crowns in accordance with claim 15, wherein the machining processes use a milling block of a tooth colored material.

18. A method for producing one or more pediatric crowns in accordance with claim 15, wherein the prefabricated pediatric crown is formed of porcelain, ceramic, resin, ceramic-resin hybrid, composite resin, plastic, glass, polycarbonate porcelain, or any other suitable tooth colored material.

19. A method for producing one or more pediatric crowns in accordance with claim 15, wherein the prefabricated pediatric crown is mass produced in accordance with desired size, function, or color.

20. A method for producing one or more pediatric crowns in accordance with claim 15, wherein various sets of prefabricated pediatric crowns are mass produced for the primary dentition.
